(19) United States
(12) Patent Application Publication
(10) Pub. No.: US 2024/0118461 A1
(43) Pub. Date: Apr. 11, 2024

(54) VIEWING ANGLE DIFFUSION FILM AND DISPLAY PANEL

(71) Applicant: TCL China Star Optoelectronics Technology Co., Ltd., Shenzhen, Guangdong (CN)

(72) Inventors: Hu DOU, Shenzhen, Guangdong (CN); Ziping WU, Shenzhen, Guangdong (CN); Gang YU, Shenzhen, Guangdong (CN)

(73) Assignee: TCL China Star Optoelectronics Technology Co., Ltd., Shenzhen, Guangdong (CN)

(21) Appl. No.: 17/294,700

(22) PCT Filed: Apr. 20, 2021
(86) PCT No.: PCT/CN2021/088412

§ 371 Date: Dec. 24, 2023

(30) Foreign Application Priority Data
Apr. 6, 2021 (CN) 202110367182.6

(51) Int. Cl. G02B 5/02

(52) U.S. Cl. CPC G02B 5/0215

(57) ABSTRACT

A viewing angle diffusion film and a display panel are provided, including a substrate and a plurality of refractive protrusions. Through arranging two adjacent refractive protrusions in a staggered layout with changes periodically in each column of refractive protrusions, that is, initial positions of each column of refractive protrusions are not on a same straight line, a Moire effect can thereby be reduced, improving a quality of the display panel.

### FIELD OF INVENTION

The present disclosure relates to the technical field of display technology, and particularly to a viewing angle diffusion film and a display panel.

### BACKGROUND

With rapid development of display technology, viewing angle diffusion film for liquid crystals having high-resolution has become a development trend. Increases in resolution of the viewing angle diffusion film for liquid crystals will result in a decrease in an aperture ratio of a pixel electrode, thereby reducing a light transmittance and negatively affecting a display brightness at a large viewing angle of the viewing angle diffusion film for liquid crystals.

### SUMMARY

### Technical Problem

In the prior art, a purpose of improving a display brightness at large viewing angles of the viewing angle diffusion film for liquid crystals can be achieved by adding a viewing angle diffusion film on a viewing angle diffusion film for liquid crystals. In the prior art, as shown in FIG. 1, a stripe-shaped viewing angle diffusion film is apparent in a bright area of a Moire pattern. The Moire pattern is caused by the superposition of two small periodic patterns of refractive protrusions of the viewing angle diffusion film, thereby producing a greater periodic pattern. This greater periodic pattern is the Moire pattern, which reduces technical effects of the viewing angle diffusion film.

Therefore, there is an urgent need to develop a new type of viewing angle diffusion film to retain positive effect of an existing viewing angle diffusion film and eliminate negative effects of the existing viewing angle diffusion film.

### Technical Solution

An object of the present application provide a viewing angle diffusion film and a display panel, comprising a substrate and a plurality of refractive protrusions. Through arranging two adjacent refractive protrusions in a staggered layout with changes periodically in each column of refractive protrusions, that is, initial positions of each column of refractive protrusions are not on a same straight line, a Moire effect can thereby be reduced, improving a quality of the display panel.

In order to achieve the above-mentioned object, the present invention provides a viewing angle diffusion film, comprising a substrate and a plurality of refractive protrusions forming a plurality of columns of refractive protrusions in parallel, wherein the plurality of refractive protrusions are arranged on the substrate in an array; and wherein in each column of refractive protrusions, two adjacent refractive protrusions are staggered.

Furthermore, in each column of refractive protrusions, a staggered distance between the left side of a first refractive protrusion and other refractive protrusions changes periodically from up to down. A staggered distance between two adjacent refractive protrusions is less than or equal to a width of the refractive protrusions.

Furthermore, each column of refractive protrusions are vertically arranged and are staggered left and right. The two adjacent refractive protrusions are connected from up to down and are staggered left and right.

Furthermore, each column of refractive protrusions are arranged obliquely and are arranged in a steplike staggered layout. The refractive protrusions are connected from up to down and are staggered left and right.

Furthermore, each column of refractive protrusions are arranged vertically and are staggered left and right. The two adjacent refractive protrusions are not connected from up to down and are staggered left and right.

Furthermore, a pattern of the refractive protrusions in each column is the same. The substrate and the refractive protrusions are integrally formed.

Furthermore, the viewing angle diffusion film further comprises a protective layer disposed on the substrate, covering the refractive protrusions.

Furthermore, the viewing angle diffusion film further comprises a polarizing film disposed on a side of the substrate away from the refractive protrusions.

The present application further provides a display panel comprising a display screen body and the viewing angle diffusion film described above, wherein the viewing angle diffusion film is provided on a light emitting side of the display screen body.

Furthermore, the display panel further comprises a backlight module arranged on a side of the display screen body away from the viewing angle diffusion film.

### Advantageous Effect

Beneficial effects of the present application are: A viewing angle diffusion film and a display panel are provided, comprising a substrate and a plurality of refractive protrusions. Through arranging two adjacent refractive protrusions in a staggered layout with changes periodically in each column of refractive protrusions, that is, initial positions of each column of refractive protrusions are not on a same straight line, a Moire effect can thereby be reduced, improving a quality of the display panel.

### BRIEF DESCRIPTION OF DRAWINGS

In order to more clearly illustrate technical solutions in embodiments of the present disclosure, a brief description of accompanying drawings used in a description of the embodiments will be given below. Obviously, the accompanying drawings in the following description are merely some embodiments of the present disclosure. For those skilled in the art, other drawings may be obtained from these accompanying drawings without creative labor.

FIG. 1 is a schematic diagram of a Moire pattern of a stripe-shaped viewing angle diffusion film provided in the prior art.

FIG. 2 is a schematic diagram of a part of a structure of a viewing angle diffusion film provided by a first embodiment of the present invention.

FIG. 3 is a schematic plan view of the viewing angle diffusion film provided by the first embodiment of the present invention.

FIG. 4 is another schematic plan view of the viewing angle diffusion film provided by the first embodiment of the present invention.

FIG. 5 is a schematic diagram of a structure of the viewing angle diffusion film provided by the first embodiment of the present invention.

FIG. 6 is a schematic diagram of a Moire pattern of the viewing angle diffusion film provided by the first embodiment of the present invention.

FIG. 7 is a schematic plan view of a viewing angle diffusion film provided by a second embodiment of the present invention.

FIG. 8 is a schematic plan view of a viewing angle diffusion film provided by a third embodiment of the present invention.

FIG. 9 is a schematic structural diagram of a display panel provided by a fourth embodiment of the present invention.

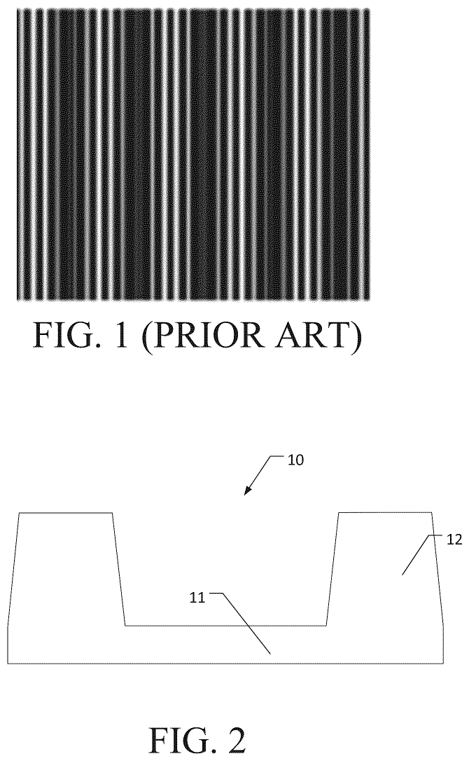

Viewing angle diffusion film 10; Substrate 11; Refractive protrusion 12.

Refractive protrusions 110; Vertical line 111.

### DETAILED DESCRIPTION

Specific structures and functional details disclosed herein are only representative, and are used for purposes of describing exemplary embodiments of the present application. However, the present application can be implemented in many alternative forms, and should not be construed as being limited only to the embodiments set forth herein.

In the description of the present disclosure, it should be understood that location or position relationships indicated by terms, such as “center”, “longitudinal”, “up”, “down”, “left”, “right”, “vertical”, “horizontal”, “top”, “bottom”, “inside”, and “outside” are location or position relationships based on illustration of the accompanying drawings, are merely used for describing the present disclosure and simplifying the description instead of indicating or implying the indicated apparatuses or elements should have specified locations or be constructed and operated according to specified locations, and Thereof, should not be intercepted as limitations to the present disclosure. Furthermore, structural elements with same or similar characteristics may be indicated by same or different reference numerals in the present disclosure. In addition, terms such as “first” and “second” are used merely for description, but shall not be construed as indicating or implying relative importance or implicitly indicating a number of the indicated technical feature. Hence, the feature defined with “first” and “second” may explicitly or implicitly includes one or more such features. In the description of the present disclosure, the term “a plurality of” means “two or more” unless otherwise specifically limited. In the description of this application, unless otherwise specified, “plurality” means two or more. In addition, the term “comprising” and any variations thereof is intended to cover non-exclusive inclusion.

### First Embodiment

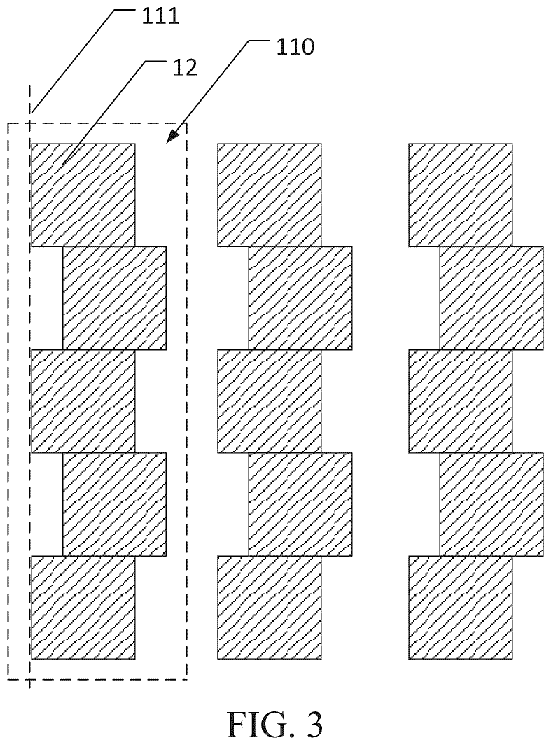

As shown in FIG. 2 and FIG. 3, the present application provides a viewing angle diffusion film 10 comprising a substrate 11 and a plurality of refractive protrusions 12.

The plurality of refractive protrusions 12 are arranged on the substrate 11 at intervals and a plurality of columns of refractive protrusions 110 are formed by the plurality of refractive protrusions 12. In each column of refractive protrusions 110, two adjacent refractive protrusions are staggered. Specifically, in each column of refractive protrusions 110, distances between two adjacent refractive protrusions 12 from a vertical line 111 are not equal and change periodically. The vertical line 111 is level with a left side of the first refractive protrusion in each column of refractive protrusions, and the first refractive protrusion is the uppermost refractive protrusion.

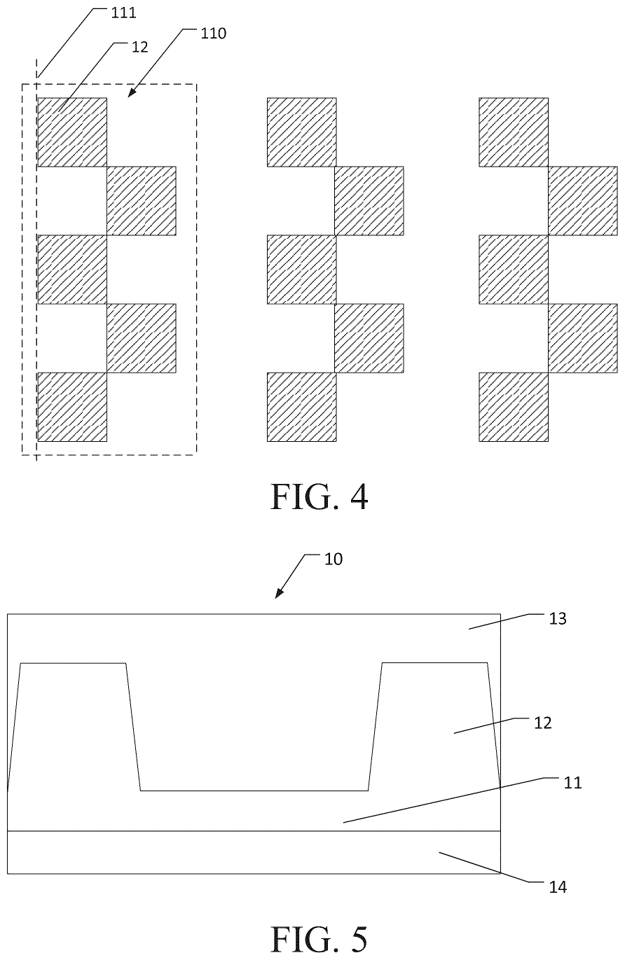

Each column of refractive protrusions 110 are vertically arranged and are staggered left and right. Two adjacent refractive protrusions 12 are connected from up to down and are staggered left and right, and a staggered distance between the two adjacent refractive protrusions 12 is a left-right staggered distance of the refractive protrusions 12, which is a distance between left sides of the two adjacent refractive protrusions. A staggered distance between the left side of the first refractive protrusion and other refractive protrusions changes periodically from up to down. In the present embodiment, in each column of refractive protrusions 110, an absolute value of a distance difference (i.e., the staggered distance) between two adjacent refractive protrusions 12 from the vertical line 111 is greater than 0 and less than or equal to a width of the refractive protrusions. In each row of refractive protrusions, the intervals between adjacent refractive protrusions are the same. In the described periodical changes from up to down in the column of refractive protrusions 110 as shown in FIG. 3, a staggered distance of the second refractive protrusion is aligned with the vertical line 111 (that is, the left side of the first refractive protrusion) is greater than 0 and less than or equal to a width of the refractive protrusions. A staggered distance between the third refractive protrusion and the vertical line 111 is 0 so that the staggered distance changes periodically. As shown in FIG. 4, a staggered distance between the second refractive protrusion and the vertical line 111 (that is, the left side of the first refractive protrusion) in a column of refractive protrusions 110 from up to down is a width of the refractive protrusions. A distance between the third refractive protrusion and the vertical line 111 is 0 so that the staggered distance changes periodically.

In the present embodiment, the refractive protrusions 12 are used to change a propagation direction of light entering the viewing angle diffusion film 10, and a part of the light is shifted away from the center of the viewing angle diffusion film 10 by light refraction, thereby enhancing a brightness at a large viewing angle.

As shown in FIG. 5, in this embodiment, the pattern of the refractive protrusions 12 in each column are the same. A cross-sectional pattern of the refractive protrusion 12 comprises a trapezoid shape. The substrate 11 and the refractive protrusions 12 are integrally formed.

The viewing angle diffusion film 10 further comprises a protective layer 13 and a polarizing film 14.

The protective layer 13 is disposed on the substrate 11 and covers the refractive protrusions 12, and the protective layer 13 is made of a transparent material for protecting the refractive protrusions 12. The polarizing film 14 is disposed on a side of the substrate 11 away from the refractive protrusions 12. It should be noted that combining the refractive protrusions 12 with the polarizing film 14 allows the viewing angle diffusion film 10 to act as a large viewing angle polarizer so that the viewing angle diffusion film 10 can replace the polarizer on the existing display panel.

The Moire pattern is caused by superposition of two small periodic patterns (that is, the adjacent refractive protrusions from up to down of the columns of refractive protrusions). Because the adjacent refractive protrusions from up to down are not staggered, a greater periodic pattern is produced, and the greater periodic pattern is the Moire pattern.

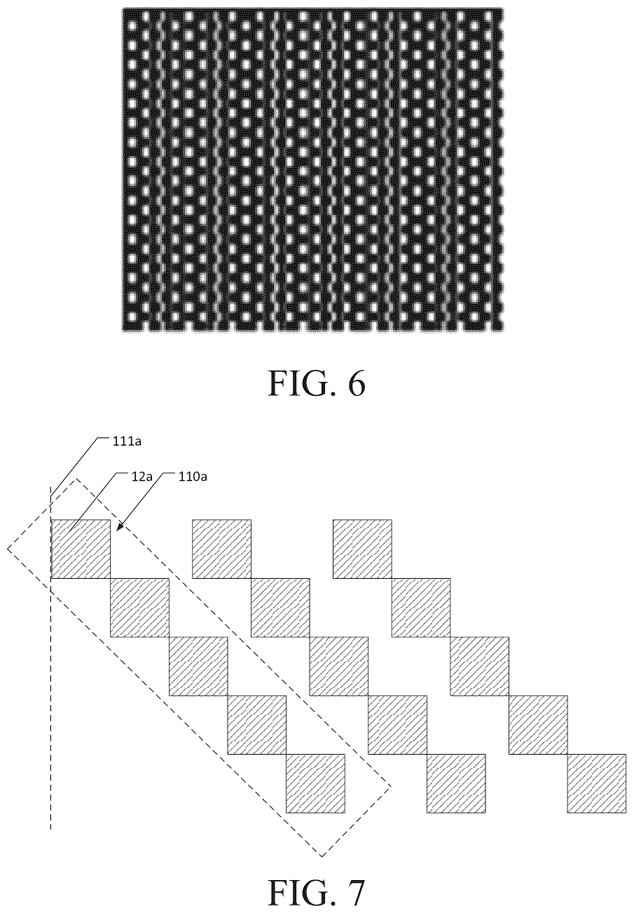

Therefore, the first embodiment of the present application provides the viewing angle diffusion film 10. In each column of refractive protrusions 110, a distance between two refractive protrusions is arranged in a staggered layout and changes periodically. That is, initial positions of each column of refractive protrusions 110 are not on a same straight line, thereby reducing a Moire effect (as shown in FIG. 6) and improving a quality of the display panel.

### Second Embodiment

As shown in FIG. 7, the second embodiment of the present application provides a viewing angle diffusion film. A difference from the first embodiment is that each column of refractive protrusions 110a are arranged obliquely and are arranged in a steplike staggered layout. The refractive protrusions 12a are connected from up to down and are staggered left and right. A staggered distance between the two adjacent refractive protrusions 12a is a staggered distance between the two adjacent refractive protrusions from left to right.

Specifically, a distance between the refractive protrusions 12a and the vertical line 111a gradually and periodically increases from up to bottom in each column of refractive protrusions 110a, and a staggered distance between two adjacent refractive protrusions 12a is gradually increased. A distance difference (i.e., the staggered distance) between two adjacent refractive protrusions 12a and the vertical line 111a is a width of the refractive protrusion 12a.

### Third Embodiment

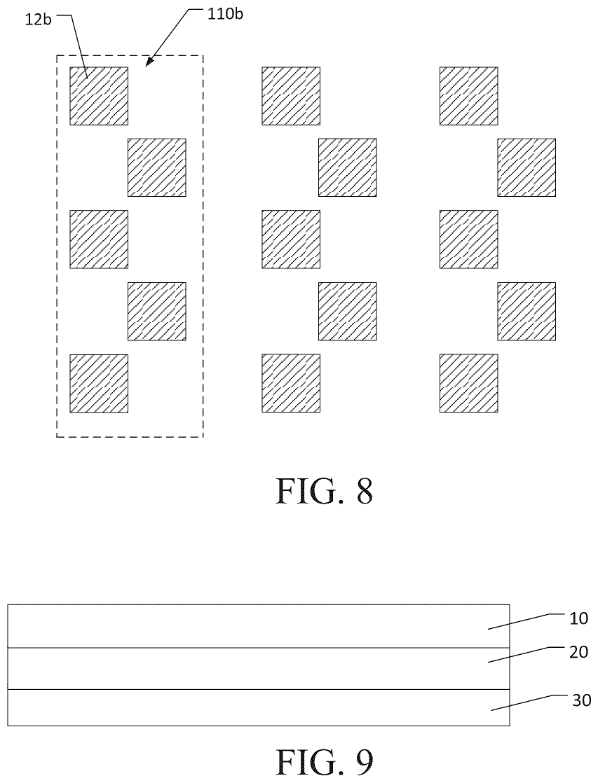

As shown in FIG. 8, the third embodiment of the present application provides a viewing angle diffusion film. A difference from the first embodiment is that each column of refractive protrusions 110b are arranged vertically and are staggered left and right. The two adjacent refractive protrusions 12b are not connected from up to down and are staggered left and right, and a staggered distance is a distance that the two adjacent refractive protrusions are staggered left and right.

### Fourth Embodiment

The fourth embodiment of the present application provides a display panel comprising a display screen body 20 and the viewing angle diffusion film 10. The viewing angle diffusion film 10 is provided on a light emitting side of the display screen body 20.

In the fourth embodiment, the display panel further comprises a backlight module 30 arranged on a side of the display screen body 20 away from the viewing angle diffusion film 10.

It should be noted that when the viewing angle diffusion film 10 is attached to the display screen body 20, the viewing angle diffusion film 10 has a light scattering effect. In this case, there is no need to add a diffusion film in the backlight module 30, thereby reducing production costs.

The above is a detailed introduction to a mobile terminal provided by an embodiment of the present application. Specific examples are used in this article to illustrate the principles and implementation of the present application. Its core idea, at the same time, for those skilled in the art, according to the idea of this application, there will be changes in the specific implementation and scope of application. In summary, the content of this specification should not be construed as a limitation to the present application.

What is claimed is:

1. A viewing angle diffusion film, comprising:
a substrate; and
a plurality of refractive protrusions, forming a plurality of columns of refractive protrusions in parallel, wherein the plurality of refractive protrusions are arranged on the substrate in an array;
wherein in each column of refractive protrusions, two adjacent refractive protrusions are staggered.

2. The viewing angle diffusion film of claim 1, wherein:
in each column of refractive protrusions, a staggered distance between a left side of a first refractive protrusion and other refractive protrusions changes periodically from up to down; and
a staggered distance between two adjacent refractive protrusions is less than or equal to a width of the refractive protrusions.

3. The viewing angle diffusion film of claim 2, wherein:
each column of refractive protrusions are vertically arranged and are staggered left and right; and
the two adjacent refractive protrusions are connected from up to down and are staggered left and right.

4. The viewing angle diffusion film of claim 2, wherein:
each column of refractive protrusions are arranged obliquely and are arranged in a steplike staggered layout; and
the refractive protrusions are connected from up to down and are staggered left and right.

5. The viewing angle diffusion film of claim 2, wherein:
each column of refractive protrusions are arranged vertically and are staggered left and right; and
the two adjacent refractive protrusions are not connected from up to down and are staggered left and right.

6. The viewing angle diffusion film of claim 1, wherein:
a pattern of the refractive protrusions in each column is the same; and
the substrate and the refractive protrusions are integrally formed.

7. The viewing angle diffusion film of claim 1, further comprising:
a protective layer disposed on the substrate, covering the refractive protrusions.

8. The viewing angle diffusion film of claim 1, further comprising:
a polarizing film disposed on a side of the substrate away from the refractive protrusions.

9. A display panel, comprising a display screen body and a viewing angle diffusion film, wherein the viewing angle diffusion film is provided on a light emitting side of the display screen body; and
the viewing angle diffusion film comprises:
a substrate; and
a plurality of refractive protrusions, forming a plurality of columns of refractive protrusions in parallel, wherein the plurality of refractive protrusions are arranged on the substrate in an array;
wherein in each column of refractive protrusions, two adjacent refractive protrusions are staggered.

10. The display panel of claim 9, wherein:
in each column of refractive protrusions, a staggered distance between a left side of a first refractive protrusion and other refractive protrusions changes periodically from up to down; and
a staggered distance between two adjacent refractive protrusions is less than or equal to a width of the refractive protrusions.

11. The display panel of claim 10, wherein:
each column of refractive protrusions are vertically arranged and are staggered left and right; and
the two adjacent refractive protrusions are connected from up to down and are staggered left and right.

12. The display panel of claim 10, wherein:
each column of refractive protrusions are arranged obliquely and are arranged in a steplike staggered layout; and
the refractive protrusions are connected from up to down and are staggered left and right.

13. The display panel of claim 10, wherein:
each column of refractive protrusions are arranged vertically and are staggered left and right; and
the two adjacent refractive protrusions are not connected from up to down and are staggered left and right.

14. The display panel of claim 9, wherein:
a pattern of the refractive protrusions in each column is the same; and
the substrate and the refractive protrusions are integrally formed.

15. The display panel of claim 9, further comprising:
a protective layer disposed on the substrate, covering the refractive protrusions.

16. The display panel of claim 9, further comprising:
a polarizing film disposed on a side of the substrate away from the refractive protrusions.

17. The display panel of claim 9, further comprising:
a backlight module arranged on a side of the display screen body away from the viewing angle diffusion film.
